(19) United States
(12) Patent Application Publication
(10) Pub. No.: US 2011/0163921 A1
(43) Pub. Date: Jul. 7, 2011

(54) UHF RFID INTERNAL ANTENNA FOR HANDHELD TERMINALS

(75) Inventor: Laurian Petru CHIRILA, Irvine, CA (US)

(73) Assignee: Psion Teklogix Inc., Mississauga (CA)

(21) Appl. No.: 12/683,294

(22) Filed: Jan. 6, 2010

(51) Int. Cl. H01Q 1/38; H01Q 1/24

(52) U.S. Cl. 343/702; 343/700 MS

(57) ABSTRACT

A microstrip antenna, such as an internal patch antenna with circular polarization diversity, configured for at least one of transmission or reception of electromagnetic waves, such as in the UHF spectrum, with respect to a surrounding environment. The antenna comprises: an antenna element isolated from an electrical ground of the antenna and configured for operating as a radiating surface for the electromagnetic waves with respect to the surrounding environment; a transmission line having a pair of electrical conductors such that a first conductor of the pair of electrical conductors is connected to the antenna element and a second conductor of the pair of electrical conductors is configured for coupling to the electrical ground, such that the transmission line is configured to conduct current flow for at least one of towards the antenna element for transmission of the electromagnetic waves from the antenna element or away from the antenna element as a result of reception of the electromagnetic waves by the antenna element; and a composite substrate having a selected dielectric constant including a plurality of individual dielectric material layers in a stacked layer arrangement, such that the composite substrate is positioned between the antenna element and the electrical ground and the antenna element is attached to a first surface of the composite substrate. Further, an optional ground element can be attached to the other side of the composite substrate and the tuning of the antenna can be dual band in the UHF or higher frequency spectra.

### FIELD OF THE INVENTION

The present invention relates to antennas and their construction.

### BACKGROUND

UHF RFID is becoming more and more popular in the field of contactless identification, tracking, and inventory management. UHF RFID is gradually replacing the more traditional barcode readers, since use of barcode labels have a significant number of disadvantages such as: limited quantity of information storage/representation of the product associated with the barcode; trying to increase the amount of data that can be stored/represented by the barcode becomes more complicated in the number of the lines and/or of the patterns that can be printed in a given space/surface; increasing the complexity of the lines and/or patterns can make the barcode label hard and slow to read and very sensitive to the distance between the label and reader; and the barcode reader must “see” the label, in other words the label must be visible to the user and to the reader.

Contrary to barcodes, UHF RFID tags (the widely used definition for UHF RFID labels) can store more information than a barcode label, and can be interrogated (the widely used definition for reading the tags) anywhere from few inches to more than 10 feet. Further, UHF RFID readers are able to read multiple tags at ones, as compared to barcode readers that are typically limited to reading of one barcode at a time. A further advantage of UHF RFID tags is that they can be interrogated even if the tag is not visible to the reader.

However, there are also significant disadvantages with current state of the art in UHF RFID handheld readers. For example, the ground plane of circular polarized UHF RFID antennas is typically greater than the dimensions of the handheld itself, thereby necessitating the location of the circular polarized UHF RFID antenna outside of the housing of the RFID handheld, i.e. external to the main terminal housing. This external configuration has a disadvantage of making the handheld bulky to use and manipulate by the user. A further disadvantage of the external configuration is that the UHF RFID antenna has a greater likelihood of damage due to impact/dropping of the handheld by the user. It is recognized that trying to decrease the size of the ground plane for current circular polarized UHF RFID antenna would result in unacceptable decreases in their performance (e.g. gain).

In order to address this external configuration problem, the existing handheld UHF RFID readers make use of a linear polarized internal RFID antenna. However, this type of RFID antenna is only able to successfully read the RFID tags that are properly aligned with the reader's internal RFID antenna, and can therefore miss the RFID tags that are not properly aligned. It is recognised that an linear RFID antenna can physically fit inside of current handheld housings, however in addition to potential missing of RFID tags that are not aligned with its polarization, linear RFID antennas interfere with WAN or other wireless communication modes that are also onboard the handheld.

Therefore, it is recognised that linear RFID antennas have a number of disadvantages but can be compact to fit inside of current handheld housings. Therefore, to address these aspects, bigger size diversity or circular polarized UHF RFID antennas are used as an external attachment to the handheld terminal. However, due to the circular polarized UHF RFID antenna size, determined by the UHF RFID frequency bands, most of these types of antenna won't fit inside the handheld, unless the gain of the circular polarized UHF RFID antenna is seriously reduced, or in other words the reading range and anti-collision ability is greatly reduced.

It is recognised that by using high dielectric constant ceramics, the RFID antenna size can be reduced but the antenna may still need a ground plane larger than the dimensions of a typical handheld terminal help to preserve the antenna's efficiency.

In order to reduce the physical size of antennas, an increase in the thickness of the dielectric substrate can be used between the metallic elements (e.g. antenna and ground plane) of the antenna. However, excessive thicknesses of dielectric substrates can result in an undesirable decrease in the dielectric constant exhibited by the substrate material for thinner substrates, which results in an overall undesirable decrease in the gain of the antenna.

### SUMMARY

There is a need for a improved antenna that overcomes or otherwise mitigates at least one of the above discussed disadvantages.

Linear RFID antennas have a number of disadvantages but can be compact to fit inside of current handheld housings. Therefore, to address these aspects, bigger size diversity or circular polarized UHF RFID antennas are used as an external attachment to the handheld terminal. However, due to the circular polarized UHF RFID antenna size, determined by the UHF RFID frequency bands, most of these types of antenna won't fit inside the handheld, unless the gain of the circular polarized UHF RFID antenna is seriously reduced, or in other words the reading range and anti-collision ability is greatly reduced. It is recognised that by using high dielectric constant ceramics, the RFID antenna size can be reduced but the antenna may still need a ground plane larger than the dimensions of a typical handheld terminal help to preserve the antenna's efficiency. In one embodiment, the effective “high” dielectric constant of the composite substrate is at least about 9, and in another it is greater than about 9 or preferably greater than 9. In order to reduce the physical size of antennas, an increase in the thickness of the dielectric substrate can be used between the metallic elements (e.g. antenna and ground plane) of the antenna. However, excessive thicknesses of dielectric substrates can result in an undesirable decrease in the dielectric constant exhibited by the substrate material for thinner substrates, which results in an overall undesirable decrease in the gain of the antenna. Contrary to existing antennas there is provided a microstrip antenna, such as a patch antenna, configured for at least one of transmission or reception of electromagnetic waves with respect to a surrounding environment. The antenna comprises: an antenna element isolated from an electrical ground of the antenna and configured for operating as a radiating surface for the electromagnetic waves with respect to the surrounding environment; a transmission line having a pair of electrical conductors such that a first conductor of the pair of electrical conductors is connected to the antenna element and a second conductor of the pair of electrical conductors is configured for coupling to the electrical ground, such that the transmission line is configured to conduct current flow for at least one of towards the antenna element for transmission of the electromagnetic waves from the antenna element or away from the antenna element as a result of reception of the electromagnetic waves by the antenna element; and a composite substrate having a selected dielectric constant including a plurality of individual dielectric material layers in a stacked layer arrangement, such that the composite substrate is positioned between the antenna element and the electrical ground and the antenna element is attached to a first surface of the composite substrate. Further, an optional ground element can be attached to the other side of the composite substrate.

A first aspect provided is a microstrip antenna configured for at least one of transmission or reception of electromagnetic waves with respect to a surrounding environment, the antenna comprising: an antenna element isolated from an electrical ground of the antenna and configured for operating as a radiating surface for the electromagnetic waves with respect to the surrounding environment; a transmission line having a pair of electrical conductors such that a first conductor of the pair of electrical conductors is connected to the antenna element and a second conductor of the pair of electrical conductors is configured for coupling to the electrical ground, such that the transmission line is configured to conduct current flow for at least one of towards the antenna element for transmission of the electromagnetic waves from the antenna element or away from the antenna element as a result of reception of the electromagnetic waves by the antenna element; and a composite substrate having a selected dielectric constant including a plurality of individual dielectric material layers in a stacked layer arrangement, such that the composite substrate is positioned between the antenna element and the electrical ground and the antenna element is attached to a first surface of the composite substrate.

A further aspect is an antenna apparatus comprising: an antenna element configured to be isolated from an electrical ground of the antenna; a transmission line having a pair of electrical conductors such that a first conductor of the pair of electrical conductors is connected to the antenna element and a second conductor of the pair of electrical conductors is configured for coupling to the electrical ground; and a composite substrate having a selected relative static permittivity including a plurality of individual relative static permittivity material layers in a stacked layer arrangement, such that the composite substrate is positioned between the antenna element and the electrical ground and the antenna element is attached to a first surface of the composite substrate.

### BRIEF DESCRIPTION OF THE DRAWINGS

These and other features of the invention will become more apparent in the following detailed description in which reference is made to the appended drawings by way of example only, wherein:

FIG. 1 is a diagram of an antenna with environment;

FIG. 2 is a first embodiment of the antenna of FIG. 1 including a composite substrate;

FIG. 3a is a further embodiment of the antenna of FIG. 2;

FIG. 3b is a further embodiment of the antenna of FIG. 2;

FIG. 4a is an embodiment of the antenna of FIG. 2 in a handheld device;

FIG. 4b is an embodiment of the antenna of FIG. 2 in a handheld device;

FIG. 5a is an embodiment of slots on the radiating element of the antenna of FIG. 2;

FIG. 5b is a further embodiment of slots on the radiating element of the antenna of FIG. 2; and

FIG. 6 is a further embodiment of the antenna of FIG. 2.

### DETAILED DESCRIPTION OF THE PREFERRED EMBODIMENTS

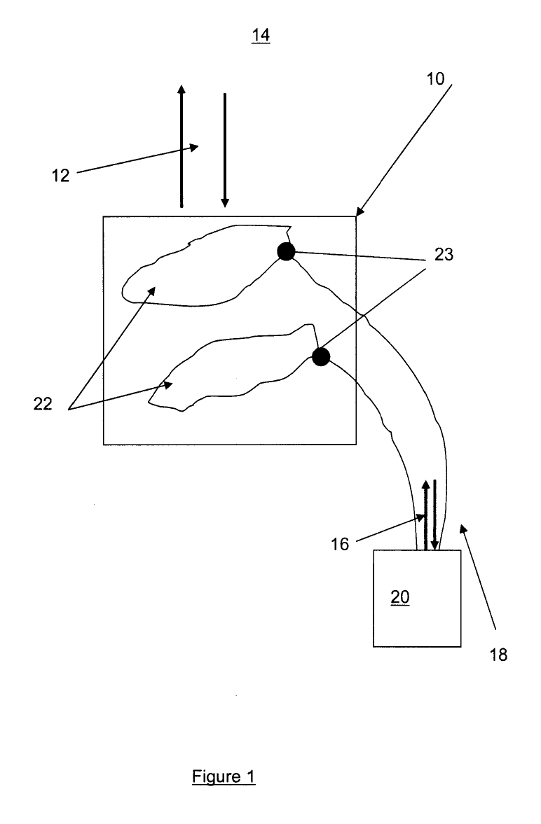

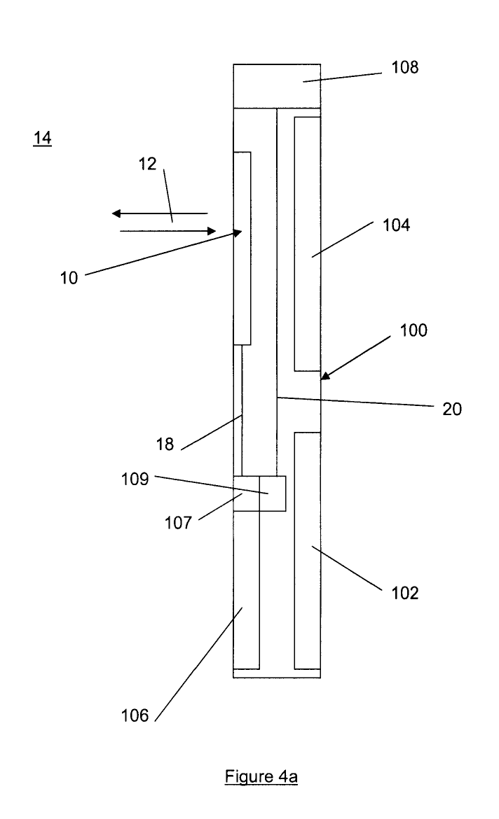

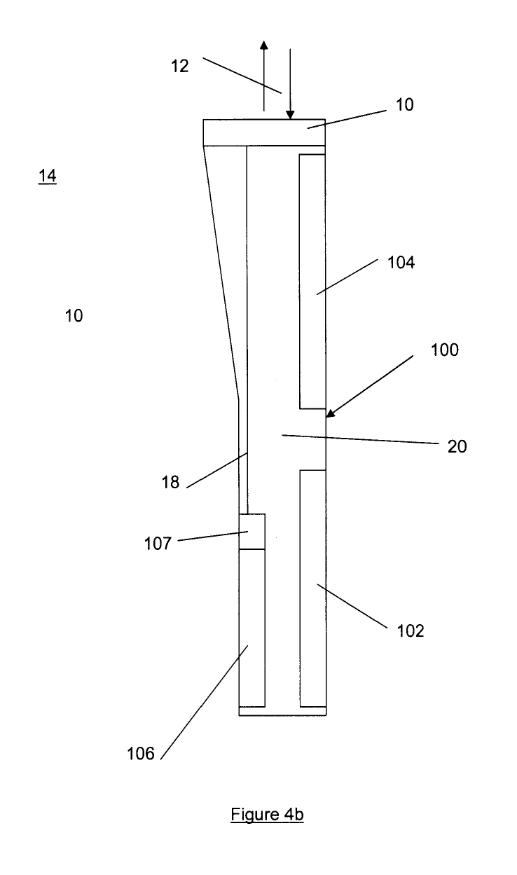

Referring to FIG. 1, an antenna 10 (or aerial) is a transducer designed to transmit and/or receive electromagnetic waves 12 from a surrounding environment 14. Accordingly, antennas 10 convert electromagnetic waves 12 into electrical currents 16 (e.g. receive operation) and convert electrical currents 16 into electromagnetic waves 12 (e.g. transmit operation), such that the electrical current 16 is communicated via a transmission line/cable/lead 18 coupled between the antenna 10 and a current source/sink 20. Antennas 10 can be used in systems such as radio and television broadcasting, point-to-point radio communication, wireless LAN, radar, product tracking and/or monitoring via Radio-frequency identification (RFID) applications, and space exploration. It is recognised that the antenna 10 can be incorporated into or otherwise coupled to a computing device such as portable handheld device 20 (e.g. an RFID reader—see FIGS. 4a,b) acting as the current source/sink.

Radio frequency (RF) radiation 12 is a subset of electromagnetic radiation 12 with a wavelength of 100 km to 1 mm, which is a frequency of 300 Hz to 3000 GHz, respectively. This range of electromagnetic radiation 12 constitutes the radio spectrum and corresponds to the frequency of alternating current electrical signals 16 used to produce and detect radio waves 12 in the environment 14. Ultra high frequency (UHF) designates a range of electromagnetic waves 12 with frequencies between 300 MHz and 3 GHz (3,000 MHz), also known as the decimetre band or decimetre wave as the wavelengths range from one to ten decimetres (10 cm to 1 metre). For example, RF can refer to electromagnetic oscillations in either electrical circuits or radiation through air and space. Like other subsets of electromagnetic radiation, RF travels at the speed of light. It is also recognised that the radio waves 12 can be detected and/or generated by the antenna 10 in frequency ranges other than in the UHF band, such as but not limited to a plurality of frequency sub-bands (e.g. dual/multi-band 3G/4G applications such as UMTS or CDMA or WiMAX or WiFi in which there are multiple so-called frequency bands—for example 700/850/900 MHz and 1800/1900/2100 MHz within two major low and high wavelength super bands). Accordingly, it is recognised that the antenna 10 described herein is not limited to UHF RFID applications and could readily be applied to any radio communication technology at UHF frequencies or higher frequencies (e.g. WAN, WIFI, Bluetooth, GPS and/or other), wherein particular advantages of the antenna 10 of reduced physical size and/or polarization diversity and/or directionality and/or multi-band capability may be appreciated. It is recognised that in particular a composite substrate 24 with comprising two or more sublayers 24a,b,c is included in the antenna 10 structure for the UHF and/or other appropriate frequency applications.

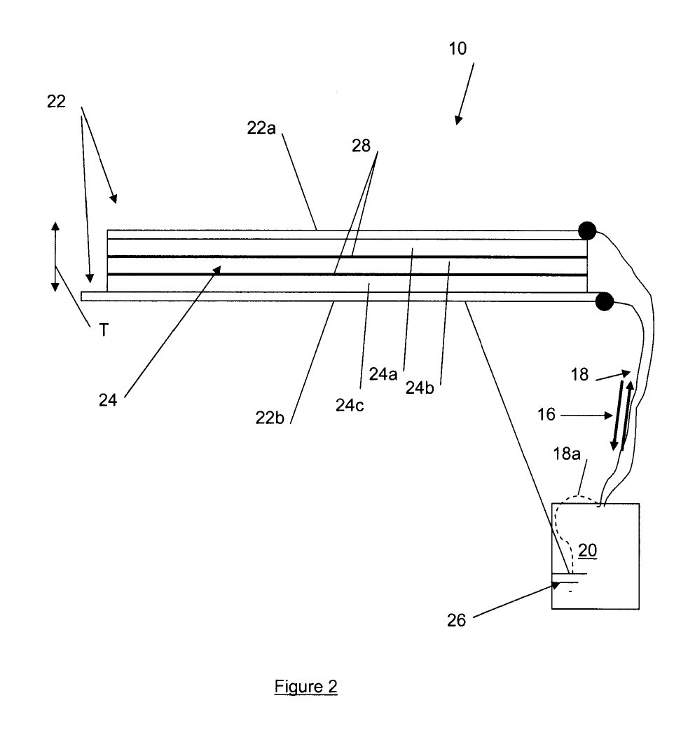

Physically, the antenna 10 is an arrangement of one or more conductors 22, usually called elements 22 in this context, such as but not limited to planes 22 of a patch antenna 10 (see FIG. 2). In transmission, the alternating current 16 is created in the elements 22 by applying a voltage at the antenna terminals 23, causing the elements 22 to radiate the electromagnetic field 12. In reception, the inverse occurs such that the electromagnetic field 12 from another source induces the alternating current 16 in the elements 22 and a corresponding voltage at the antenna's terminals 23. Some receiving antennas 10 (such as parabolic and horn types) incorporate shaped reflective surfaces to collect EM waves 12 from free space and direct or focus them onto the actual conductive elements 22.

Antennas 10 can be most commonly employed in air or outer space environment 14, but the antennas 10 can also be operated in under water or even through soil and rock environments 14 at certain frequencies for specified distances. It is recognised that the words antenna and aerial can be used interchangeably; but typically a rigid metallic structure is termed an antenna and a wire format is called an aerial.

There are two fundamental types of antenna 10 directional patterns, which, with reference to a specific two dimensional plane (usually horizontal [parallel to the ground] or vertical [perpendicular to the ground]), are either: omni-directional (radiates equally in all directions), such as a vertical rod (in the horizontal plane); or directional (radiates more in one direction than in the other). For example, omni-directional can refer to all horizontal directions with reception above and below the antenna 10 being reduced in favour of better reception (and thus range) near the horizon. A directional antenna 10 can refer to one focusing a narrow beam in a specified specific direction or directions. By adding additional elements (such as rods, loops or plates) and arranging their length, spacing, and orientation, an antenna 10 with desired directional properties can be created. An antenna 10 array can be defined as two or more simple antennas 10 combined to produce a specific directional radiation 12 pattern, such that the array is composed of active elements 22. Antenna 10 arrays may be built up from any basic antenna 10 type, such as dipoles, loops or slots.

The gain as an antenna 10 parameter measures the efficiency of a given antenna 10 with respect to a given norm, usually achieved by modification of its directionality. An antenna 10 with a low gain emits radiation 12 with about the same power in all directions, whereas a high-gain antenna 10 will preferentially radiate 12 in particular directions. Specifically, the gain, directive gain or power gain of the antenna 10 can be defined as the ratio of the intensity (power per unit surface) radiated 12 by the antenna 10 in a given direction at an arbitrary distance divided by the intensity radiated 12 at the same distance by a hypothetical isotropic antenna 10.

In any event, it is recognised that the antenna 10 can comprise: an antenna element 22a configured to be isolated from an electrical ground 22b of the antenna 10; a transmission line 18 having a pair of electrical conductors such that a first conductor of the pair of electrical conductors is connected to the antenna element 22a and a second conductor of the pair of electrical conductors is configured for coupling to the electrical ground 22b; and a composite substrate 24 having a selected relative static permittivity including a plurality of individual relative static permittivity material layers 24a,b in a stacked layer arrangement, such that the composite substrate 24 is positioned between the antenna element 22a and the electrical ground 22b and the antenna element 22a is attached to a first surface of the composite substrate 24.

### Microstrip Antennas

In telecommunication, there are several types of microstrip antennas 10 (also known as printed antennas), the most common of which is the microstrip patch antenna 10 or patch antenna 10 type. Referring to FIG. 2, the microstrip antenna 10 of the present embodiments is an antenna 10 (e.g. narrowband, wide-beam) fabricated by etching or otherwise positioning an antenna element 22 (i.e. antenna element 22a) pattern in metal trace (e.g. a plurality of metallic lines such as a fractal pattern and/or other geometrical shapes such as a circle, square, rectangle, ellipse, or other solid/continuous shapes) bonded (e.g. via adhesive) to a composite substrate 24 with dielectric properties, with an optional metal layer (e.g. continuous) bonded to the opposite side of the composite substrate 24 used as an antenna grounding structure 22b (for establishing a reference potential level for operating the active antenna 10). The antenna grounding structure 22b can be any structure closely associated with (or acting as) the ground which is connected to the terminal of the signal receiver or source 20 opposing the active antenna terminals 23. It is recognised in FIG. 2 that the illustrated shapes of the elements 22a,22b are by example only, and as such the metallic elements 22a,b can take the form of shapes such as but not limited to planar or non-planar shapes (e.g. square, circular, rectangular, ellipse, etc.) and/or multiple traces (e.g. lines of selected width) configured into a selected pattern (e.g. fractal).

For example, microstrip antennas 10 can be usually employed at UHF and higher frequencies since the size of the antenna can influence the wavelength at the resonance frequency of the antenna 10.

The overall composite substrate 24 of the antenna 10 is composed of a plurality of dielectric layers 24a,b,c (e.g. two or more layers) of a selected dielectric material (or materials). It is recognised that the dielectric material of the each of the substrate layers 24a,b,c can be the same or different dielectric materials. Further, selected pairs of the dielectric material layers 24a,b,c can be separated from one another by a bonding layer 28 there-between, such that the bonding layer 28 splits the composite substrate 24 up into a plurality of individual dielectric layers 24ab,c.

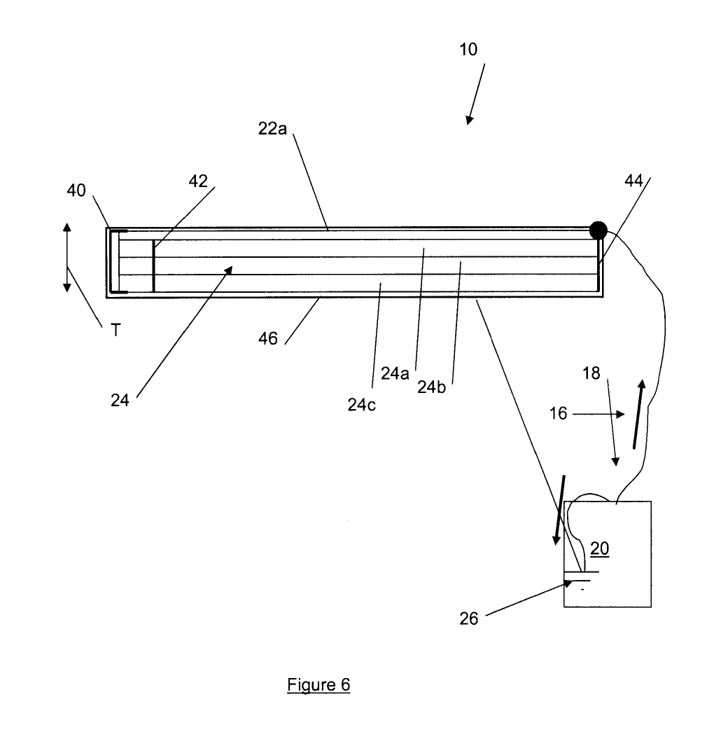

In other words, the substrate 24 is not a continuous dielectric material/medium through the thickness “T” between the elements 22a,b, rather the composite substrate 24 is materially discontinuous between the antenna element 22a and the ground element 22b by being composed of a number of stacked sublayers 24a,b,c (i.e. a stack comprising more than one layer 24a,b,c—e.g. 2 layers, 3 layers, 4 layers, 5 layers, six layers, or some other selected number of sublayers 24a,b,c, greater than two). It is recognised: any pair of sublayers 24a,b,c in the layer stack arrangement can be positioned directly adjacent to one another (i.e. their respective opposed surfaces in direct contact with one another—see FIG. 6) in the layer stack arrangement; any pair of sublayers 24a,b,c in the layer stack arrangement can be positioned in an opposed spaced apart relationship with respect to one another (i.e. their respective opposed surfaces are not in direct contact with one another and are instead separated from one another by a defined space/distance—see FIG. 2) in the layer stack arrangement; or a combination thereof for different pairs of sublayers 24a,b,c in the layer stack arrangement of the composite substrate 24.

In terms of the opposed spaced apart relationship between a pair of sublayers 24a,b,c, the space between the opposed sublayers 24a,b,c can be “empty” (e.g. filled with air or other gaseous or liquid fluid), can include a number of positioned spacers, or can be provided as an interposed layer 28 having a dielectric constant different (or the same) from the dielectric constant of the sublayer 24a,b,c material. One example of the interposed layer 28 is an adhesive material 28 (e.g. having a dielectric constant of between 2-4. Referring to FIG. 6, in the case where the interposed layer 28 is not an adhesive (see FIG. 2), or in the case where there is no interposed layer 28 at all, the sublayers 24a,b,c can be coupled to one another by clamps/clips 40 (e.g. external to the layer stack of the composite substrate 24), by fasteners 42 (e.g. threaded fasteners, nut and bolt type fasteners, rivets, etc.) penetrating through the thickness T of the layer stack of the composite substrate 24, external layers 44 laminated/bonded to the composite substrate 24 (e.g. coupling the external sides of the sublayers 24a,b,c to one another) and/or by a housing 46 (e.g. plastic envelope for the antenna 10). Further, it is recognised that the clamps/clips 40, the fasteners 42, the external layers 44, and/or the housing 46 can be fabricated from non metallic and non conductive material (e.g. plastic, polyethylene or similar) to inhibit. shortcutting/short-circuiting the antenna element 22a with the ground element 22b, which would compromise the antenna 10 performance.

Accordingly, it is recognised that the composite substrate 24 is advantageous as a substrate with selected dielectric properties, as the material discontinuity of the sublayers 24a,b,c provides for a higher overall dielectric constant for the stack layer arrangement as compared to a single block type of dielectric substrate 24 of similar thickness T.

Further, it is recognised that microstrip antenna 10 radiator shapes can be such as but not limited to; square, rectangular, circular and elliptical, but any continuous shape is possible. Because such antennas 10 have a very low profile, the antennas 10 can be mechanically rugged and can be conformable, such that the antenna can be mounted on the exterior of aircraft and spacecraft, or are incorporated into mobile radio communications devices 20. Further, the microstrip antenna 10 can also be relatively inexpensive to manufacture and design because of the simple 2-dimensional physical geometry. The antenna 10 can be employed at UHF and higher frequencies because the size of the antenna 10 is directly tied to the wavelength at the resonance frequency, based on a selected thickness T of the composite substrate 24. A single patch antenna 10 can provide a directive gain of around 6-9 dBi, for example. It is also envisioned to print an array of patches (e.g. antenna element 22a) on a single (large) substrate 22b using lithographic techniques. Patch arrays can provide higher gains than a single patch at little additional cost; matching and phase adjustment can be performed with printed microstrip feed structures, again in the same operations that form the radiating patches. The ability to create high gain arrays in a low-profile antenna 10 is one reason that patch arrays can be used on airplanes and in other military applications. For example, an array of patch antennas can be used to make a phased array of antennas 10 with dynamic beamforming ability.

### Antenna Element 22a

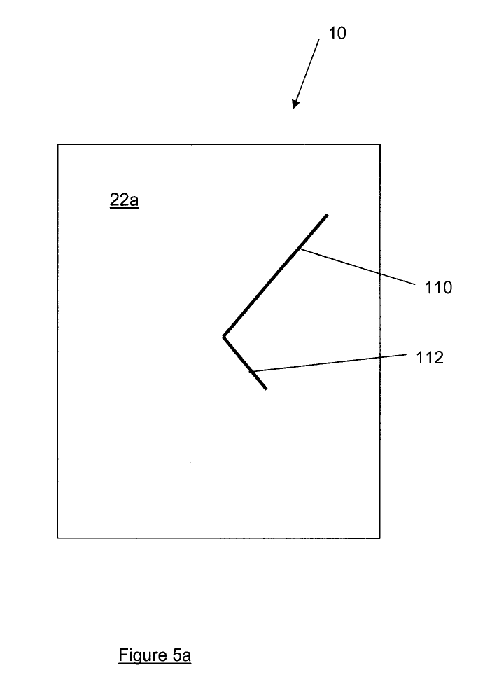

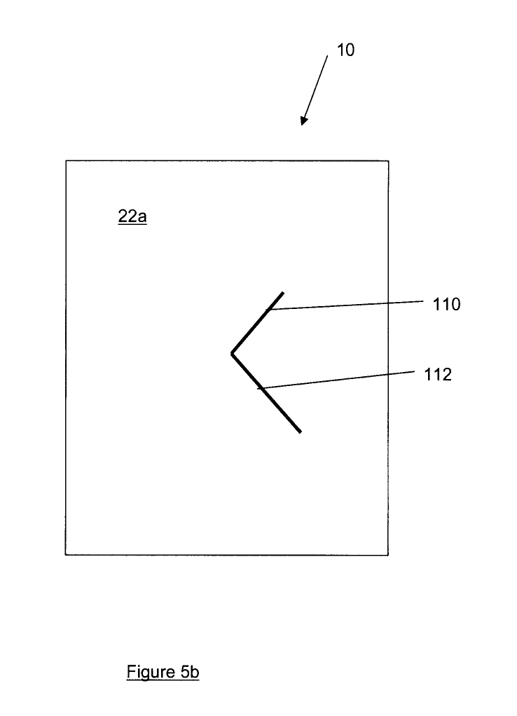

The antenna element 22a operates as radiating surface for impinging electromagnetic radiation 12 coming from or going to the active antenna 10. For example, the antenna element 22a is not connected to the ground 26, as compared to the provided configuration of ground element 22b. Instead, the antenna element 22a is electrically insulated from the ground 26. It is recognised that one or more linear slots and/or grooves 110,112 in the exterior surface (facing the environment 14) of the antenna element 22a can be used for tuning of the antenna 10 to desired frequency bands and/or for desired polarization diversities, see FIGS. 5a,b. It is also recognised that these linear slots and/or grooves 110,112 can also be used to account for non-equal side dimensions of the element 22a (e.g. rectangular and therefore no square), thus making the rectangular shaped antenna element 22a appear to the antenna 10 as square shaped and thus compatible with circular polarized diversity tuning for the antenna 10.

### Grounding Structure Element 22b

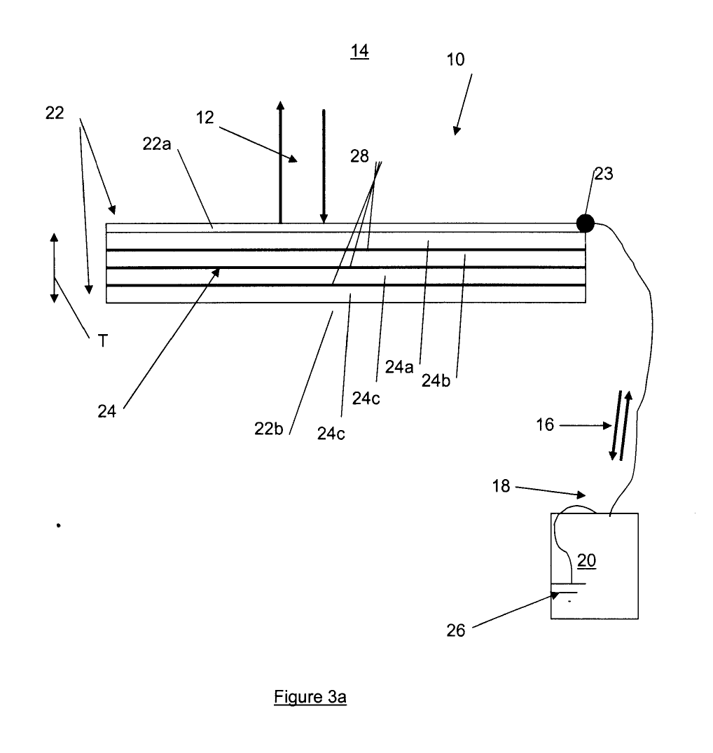

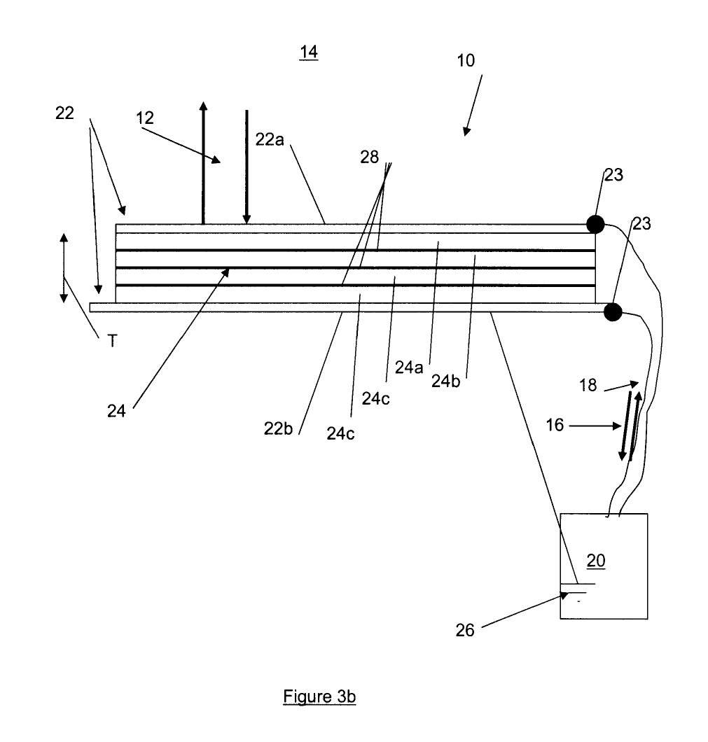

An example of the grounding structure 22b is a ground plane 22b (see FIG. 3a as a metal layer bonded to the underside—in opposite to the antenna element 22a—of the substrate 24) connected to a ground 26 and/or the ground 26 itself (i.e. one of the conductors of the transmission line 18 is connected to the ground 26 itself shown by ghosted line 18a as an example embodiment). It is recognised that the ground 26 is a metallic structure that may not be part of the antenna 10 itself, rather is a metal structure associated with the current source/sink 20 (e.g. an electrical ground of a handheld terminal that is coupled to the antenna 10 via the transmission line 18).

An antenna grounding structure 22b can be referred to as a structure for establishing a reference potential level for operating the active antenna element 22a. The antenna grounding structure 22b can be any structure closely associated with (or acting as) the ground 26 which is connected to the terminal 23 of the signal receiver or source opposing the active antenna terminal 23. In telecommunication, a ground plane structure 22b or relationship exists between the antenna 22a and another object, where the only structure of the object is a structure which permits the antenna 22a to function as such (e.g., forms a reflector or director for an antenna). This sometimes serves as the near-field reflection point for an antenna 10, or as a reference ground in a circuit. A ground plane 22b can also be a specially designed artificial surface (such as the radial elements of a quarter-wave ground plane antenna 10). Artificial (or substitute) grounds (e.g., ground planes 22b) concerns the grounding structure for the antenna 10 and includes the conductive structure used in place of the earth and which grounding structure is distinct from the earth. For example, a ground plane 22b in the antenna 10 assembly is a layer 22b of copper that appears to most signals 12 as an infinite ground potential. The use of the ground plane 22b can help reduce noise and help provide that all integrated circuits within a system (e.g. handheld 20) compare different signals' voltages to the same potential. The ground plane 22b can also serve to make the circuit design of the antenna 10 more straightforward, allowing for the ground without having to run multiple tracks; such that any component (of the antenna 10 and/or the handheld 20) needing grounding is routed directly to the ground plane 22b.

It is also recognised that the ground plane 22b can sometimes be split and then connected by a thin trace. The thin trace can have low enough impedance to keep the connected sides (portions) of the ground plane 22b very close to the same potential while keeping the ground currents of one side/portion from significantly impacting the other, as provided by one or more respective transmission lines 18.

### Transmission Line/Cable 18

As shown in FIG. 2, the transmission (e.g. feed) line 18 in a radio transmission, reception or transceiver system is the physical cabling 18 that carries the RF signal 16 to and/or from the antenna 10. The feed line 18 carries the RF energy for transmission and/or as received with respect to the antenna 10. There are different types of feed lines 18 in use in modern wireless antenna 10 systems, lines 18 such as but not limited to: the coaxial type, the twin-lead, and, at frequencies above 1 GHz, a waveguide. For example, the coaxial cable 18 is a rounded cable with a center conductor and a braided or solid metallic shield, usually copper or aluminum. The center conductor is separated from the outer shield by an insulator material, such that the center conductor is connected to the antenna element 22a and the braided/solid metallic shield is connected to the ground plane 22b and/or the ground 26, such that the antenna element 22a is separated electrically by the composite substrate 24.

The current flow in the elements 22a,b is along the direction of the feed line 18, so the magnetic vector potential and thus the electric field follow the current flow. The radiation 12 can be regarded as being produced by the “radiating slots” at top and bottom, or equivalently as a result of the current flowing on the patch 22a and the ground plane 22b (or equivalent ground structure 22b).

### Composite Substrate 24

The dielectric loading of a microstrip antenna 10 affects both its radiation pattern and impedance bandwidth. As the dielectric constant of the substrate 24 increases, the antenna 10 bandwidth decreases which increases the Q factor of the antenna 10 and therefore decreases the impedance bandwidth. The radiation from a rectangular microstrip antenna 10 may be understood as a pair of equivalent slots. These slots act as an array and have the highest directivity when the antenna 10 has an air dielectric and decreases as the antenna is loaded by substrate 24 material with increasing relative dielectric constant.

The overall composite substrate 24 is composed of a plurality of dielectric layers 24a,b,c (e.g. two or more layers) of a selected dielectric material (or materials), such that selected pairs of the dielectric material layers 24a,b,c are separated from one another by the bonding layer 28 there-between (e.g. comprised of adhesive). It is recognised that the dielectric property of the composite substrate 24 provides for an electrically insulating material positioned between the metallic elements 22 (e.g. plates) of the antenna 10. A good dielectric typically contains polar molecules that reorient in external electric field, such that this dielectric polarization can increases the antenna's 10 capacitance. In FIG. 2,

Generalizing this, any insulating substance can be called a dielectric. While the term “insulator” refers to a low degree of electrical conduction, the term dielectric is typically used to describe materials with a measured high polarization density. The relative static permittivity (or static relative permittivity) of a material under given conditions is a measure of the extent to which it concentrates electrostatic lines of flux. It is the ratio of the amount of stored electrical energy when a potential is applied, relative to the permittivity of a vacuum. The relative static permittivity is the same as the relative permittivity evaluated for a frequency of zero. Other terms for the relative static permittivity are the dielectric constant, or relative dielectric constant, or static dielectric constant. It is recognised that relative permittivity of the dielectric material of the layers 24a,b,c can refer to a relative permittivity as either static or frequency-dependent relative permittivity depending on context. The relative static permittivity, ∈r, can be measured for static electric fields as follows: first the capacitance of a test capacitor, C0, is measured with vacuum between its plates. Then, using the same capacitor and distance between its plates the capacitance Cx with a dielectric between the plates is measured. The relative dielectric constant can be then calculated as ∈r=Cx/C0. For time-variant electromagnetic fields 12, this quantity becomes frequency dependent and in general is called relative permittivity.

Referring to FIG. 3a, a patch antenna 10 using a metallic sheet antenna element 22a is bonded to a composite substrate 24 providing a dielectric resonator property, comprised of the plurality of dielectric layers 24a,b,c,d and interposed bonding layers 28. The ground lead of the transmission line 18 is connected directly to ground 26, such that the antenna 10 does not have a metallic sheet ground element 22b.

A dielectric resonator property can be defined as an electronic component that exhibits resonance for a selected narrow range of frequencies, generally in the microwave band. The resonance of the composite substrate 24 can be similar to that of a circular hollow metallic waveguide, except that the boundary is defined by large change in permittivity rather than by a conductor. Dielectric resonator property of the composite substrate 24 is provided by a specified thickness T of dielectric material, in this case as a plurality of separated layers 24a,b,c,d (e.g. ceramic) such that each f the layers 24a,b,c,d have a large dielectric constant and a low dissipation factor. The resonance frequency of the composite substrate 24 is determined by the overall physical dimensions of the composite substrate 24 and the dielectric constant of the material(s) used in the layers 24a,b,c,d.

It is recognised that dielectric resonators can be used to provide a frequency reference in an oscillator circuit, such that an unshielded dielectric resonator is used in the antenna 10 to facilitate radiation 12. One example of the dielectric material of the layers 24a,b,c,d is Taconic RF laminates such as CER-10 RF & Microwave Laminate. The CER-10 material has a dielectric Constant @ 10 GHz of 10 based on a test method of IPC TM 650 2.5.5.6.

Referring to FIG. 3b, a patch antenna 10 using a metallic sheet antenna element 22a is bonded to a composite substrate 24 providing a dielectric resonator property, comprised of the plurality of dielectric layers 24a,b,c,d and interposed bonding layers 28, and opposingly bonded to a metallic sheet ground element 22b. The ground lead of the transmission line 18 is connected directly to the metallic sheet ground element 22b and the metallic sheet ground element 22b is connected to the ground 26 (e.g. of the current source/sink).

### Planar Patch Antenna 10

Referring to FIGS. 3a,b, shown is a patch antenna 10 (e.g. rectangular). The rectangular patch antenna 10 has an advantage inherent to patch antennas 10 of the ability to have polarization diversity. Patch antennas can easily be designed to have Vertical, Horizontal, Right Hand Circular (RHCP) or Left Hand Circular (LHCP) Polarizations, using multiple feed points, or a single feedpoint with asymmetric patch structures, further described below. This unique property allows patch antennas 10 to be used in many types of communications links that may have varied requirements. One example of the patch antenna 10 includes a square conductor 22a mounted over a ground plane 22b. Another example of a planar antenna is the Tapered Slot Antenna (TSA), otherwise referred to as a Vivaldi-antenna

A patch antenna 10 (also known as a Rectangular Microstrip Antenna) is named as attributed to the fact that it includes the metal patch 22a suspended over a ground plane 22b, where provided. The patch antenna 10 is generally constructed on the dielectric substrate 24, for example employing the same sort of lithographic patterning used to fabricate printed circuit boards. The simplest patch antenna 10 uses a patch 22a which is one half-wavelength-long with the dielectric loading included over a larger ground plane 22b separated by a constant thickness dielectric substrate 24.

It is recognised that electrically large ground planes 22b can produce stable patterns 12 and lower environmental sensitivity but of course make the antenna 10 bigger and therefore unable to be incorporated into the handheld 20 as an internal antenna 10. Accordingly, one embodiment of the current antenna 10 uses a relatively thicker multi-layered substrate 24 with a reduced dimension antenna element 22a and optional ground plane 22b. For example, the ground plane 22b can be the same size or only modestly larger than the active patch 22a. It is recognised that when a ground plane 22b is close to the size of the radiator element 22a, the ground plane 22b can couple and produce currents along the edges of the ground plane 22b which also can contribute to the radiation 12. In this case, the antenna radiation 12 pattern becomes the combination of the two sets of radiators.

The addition of the ground plane 22b to the antenna 10 can cut off most or all radiation 12 behind the antenna 10, thereby reducing the power averaged over all directions by a factor of 2 (and thus increasing the gain). The impedance bandwidth of the patch antenna 10 is strongly influenced by the spacing (thickness T) between the patch 22a and the ground plane 22b. As the patch 22a is moved closer to the ground plane 22b, less energy is radiated and more energy is stored in the patch capacitance and inductance: that is, the quality factor Q of the antenna 10 increases. However, using a single thickness substrate 24 for increasingly larger thickness T can result in substantive decreases in the dielectric constant exhibited by the substrate 24 material. Accordingly, the use of multi-layers 24a,b,c,d is used to make the composite substrate 24 to help inhibit substantive decreases in dielectric constant for the substrate 24.

For example, using a dielectric material of [Arlon AD1000 with a DK of 10.9] gave larger relative decreases in gain for increasing single layer dielectric material thickness for a single layer substrate 24 antenna 10. For a single ½ inch thick T substrate 24, a relative measured (via an EM scanner) radiative power gave a −3.2 dB, for 2 layers 24a,b with an interposed bonding layer 28 gave a relative measure radiative power of −2.9 dB, for 3 layers 24a,b,c with interposed bonding layers 28 gave a relative measure radiative power of −1.88 dB, and for 4 layers 24a,b,c,d with interposed bonding layers 28 gave a relative measure radiative power of −1.2 dB (demonstrative of almost a 2 dB difference between the one layer and the four layer case). In the before mentioned examples, the total thickness of the substrate 24 was kept relatively constant (e.g. one layer was ½ inch thick, two layers were each ¼ inch thick for ½ inch total and for four layers they were each ⅛ inch thick for ½ inch total). Each example was different and the thickness increased from ⅛″ to 4/8″ or ½″ thick. Also, the dielectric constant for the material is approximately 10.9 and for the effective dielectric constant of the composite substrate 24 as the four layer example was approximately 10.67. This is in comparison to the dielectric constant of a ½ inch thick single layer substrate 24 of approximately 10. In one preferred embodiment, the effective dielectric constant may be from approximately 6 to approximately 25, and in a more preferred embodiment, from approximately 9 to approximately 20.

### Circular Polarization

Polarization is the sum of the E-plane orientations over time projected onto an imaginary plane perpendicular to the direction of motion of the radio wave 12. In the most general case, polarization is elliptical (the projection is oblong), meaning that the antenna 10 varies over time in the polarization of the radio waves 12 it is emitting/receiving. Two special cases are linear polarization (the ellipse collapses into a line) and circular polarization (in which the ellipse varies maximally). In linear polarization the antenna 10 compels the electric field of the emitted radio wave 12 to a particular orientation. Depending on the orientation of the antenna 10 mounting, the usual linear cases are horizontal and vertical polarization. In circular polarization, the antenna 10 continuously varies the electric field of the radio wave 12 through all possible values of its orientation with regard to the Earth's surface. Circular polarizations, like elliptical ones, can be classified as right-hand polarized or left-hand polarized using a “thumb in the direction of the propagation” rule. For example, optical researchers use the same rule of thumb, but pointing it in the direction of the emitter, not in the direction of propagation, and so can be opposite to radio engineers' usage.

It is also possible to fabricate patch antennas 10 that radiate circularly-polarized waves 12. One approach is to excite a single square patch 22a using two feeds 18, with one feed 18 delayed by 90° with respect to the other. This arrangement can drive each transverse mode TM10 and TM01 with equal amplitudes and 90 degrees out of phase. Each mode radiates separately and combine to produce circular polarization. This feed 18 condition is often achieved using a 90 degree hybrid coupler. When the antenna 10 is fed in this manner, the vertical current flow is maximized as the horizontal current flow becomes zero, so the radiated electric field 12 will be vertical; one quarter-cycle later, the situation will have reversed and the field 12 will be horizontal. The radiated field 12 will thus rotate in time, producing a circularly-polarized wave 12.

An alternative is to use a single feed 18 but introduce some sort of asymmetric slot 110,112 (see FIGS. 5a,b) or other feature on the patch 22a, causing the current distribution to be displaced. The circular polarisation can be achieved without the slots 110,112, just by positioning the feed point on a diagonal of the square patch 22a. The slots 110,112 can be used to help reduce the physical size dimensions of the antenna 10, such that without the slots 110,112 the patch antenna 10 would be relatively larger than with the slots 110,112. A square patch 22a which has been perturbed slightly to produce a rectangular microstrip antenna 10 can be driven along a diagonal (for example using two orthogonal slots 110,112) and produce circular polarization. The aspect ratio of this rectangle shaped patch 22a is chosen so each orthogonal mode (TM10 and TM01 modes) are both non-resonant. At the driving point of the antenna 10 one mode is +45 degrees and the other −45 degrees to produce the required 90 degree phase shift for circular polarization, for example.

Note that, while circular patches 22a can be used for these techniques, a circular patch 22a does not inherently radiate circularly-polarized waves 12. A circular patch 22a with a single feed point 18 can create linearly-polarized radiation 12. If the circular patch antenna 10 is perturbed into an ellipse and fed properly it can produce circularly polarized electromagnetic waves 12.

Further, in electrodynamics, circular polarization (also circular polarisation) of electromagnetic radiation 12 is a polarization such that the tip of the electric field vector, at a fixed point in space, describes a circle as time progresses. The electric vector, at one point in time, describes a helix along the direction of wave 12 propagation. The magnitude of the electric field vector is constant as it rotates. Circular polarization is a limiting case of the more general condition of elliptical polarization. Circular (and elliptical) polarization is possible because the propagating electric (and magnetic) fields can have two orthogonal components with independent amplitudes and phases (and the same frequency). It is also recognised that a circularly polarized wave 12 may be resolved into two linearly polarized waves 12, of equal amplitude, in phase quadrature (90 degrees apart) and with their planes of polarization at right angles to each other.

In view of the above, circular polarization may be referred to as right or left, depending on the direction in which the electric field vector rotates. In electrical engineering, however, it is more common to define polarization as seen from the source, such as from a transmitting antenna 10. In the U.S., Federal Standard 1037C also defines the handedness of circular polarization in this manner, or as looking in the direction of propagation of the waves 12. To avoid confusion, polarization can be specified as seen from the receiver (or transmitter) when discussing polarization matters.

### Specific Antenna Example Configuration

Referring to FIGS. 3a,b, a microstrip antenna 10, such as an internal patch antenna with circular polarization diversity, is configured for at least one of transmission or reception of electromagnetic waves 12, such as in the UHF spectrum, with respect to a surrounding environment 14. The antenna 10 comprises: an antenna element 22a isolated from an electrical ground 26 of the antenna 10 and configured for operating as a radiating surface for the electromagnetic waves 12 with respect to the surrounding environment 14. The antenna 10 also has a transmission line 18 having a pair of electrical conductors such that a first conductor of the pair of electrical conductors is connected to the antenna element 22a and a second conductor of the pair of electrical conductors is configured for coupling to the electrical ground 26, such that the transmission line 18 is configured to conduct current flow 16 for at least one of towards the antenna element 22a for transmission of the electromagnetic waves 12 from the antenna element 22a or away from the antenna element 22a as a result of reception of the electromagnetic waves 12 by the antenna element 22a. The composite substrate 24 has a selected dielectric constant including a plurality of individual dielectric material layers 24a,b,c in a stacked layer arrangement, such that the composite substrate 24 is positioned between the antenna element 22a and the electrical ground 26 (e.g. embodied as a ground plane 22b) and the antenna element 22a is attached to a first surface of the composite substrate 24. Further, the optional ground element 22b can be attached to the other side of the composite substrate 24 and the tuning of the antenna 10 can be dual band in the UHF spectrum.

Accordingly, the antenna 10 can be provided using a combination of techniques like multi layer 24a,b,c dielectrics and slot 110,112 into the radiant surface 22a to facilitate a reduction in the physical sizes of the UHF RFID antenna 10 as compared to other state of the art antennas, thereby helping to provide a form factor of the antenna 10 to make it possible to embed it into the handheld terminal 20 (see FIGS. 4a,b). The handheld terminal 20 can have the antenna 10 coupled via line 18 to a battery 106 and a transceiver 107 (for example as a transmitter only for transmitting, a receiver only for receiving or combined as the transceiver for both transmission and reception of the waves 12) and housed at lease partially in the main housing 100 of the handheld 20 (e.g. on the backside of the housing opposite a display 104 and/or a keyboard 102). Another configuration example is on then end of the handheld 20 adjacent to the display 104 and/or the keypad 102.

Referring to FIG. 4b, shown is an embodiment of the handheld 20 where the antenna 10 is coupled via line 18 to the battery 106 and a first transceiver 107 and housed at lease partially in the main housing 100 of the handheld 20 (e.g. on the backside of the housing opposite the display 104 and/or the keyboard 102). The handheld 20 also includes at least one additional antenna 108 connected to at least one additional transmitter, receiver or transceiver 109. It is recognised that the antenna 10 is configured to function simultaneously with the WAN, WIFI and Bluetooth communication technologies antenna(s) 108 (e.g. non-directional based antennas as compared to the directional embodiment of the antenna 10).

It is recognised that the size of an RFID patch antenna 10 it is given by the [¼ of the] wavelength of the UHF RFID frequencies. For the 850-950 MHz frequency range the wavelength will be around [350 mm and the ¼ of the wavelength will be] 90 mm. Any traditional square patch antenna with a ground plane smaller than 90×90 mm will lose a lot in its gain and consequently the reading range or the anti-collision will be reduced, and therefore increasing the thickness T between the elements 22 by using the composite substrate 24 and/or usage of slots 110,112 can help in approximately maintaining or otherwise improving the performance of the antenna 10 as compared to larger form factor (i.e., length and width) antennas. For example, this new antenna 10 can perform better than a traditional antenna with a non-composite substrate (e.g., 90×90 mm square patch), having physical dimensions of only 64 mm×80 mm of a rectangular shape. It is also recognised that the antenna 10 can also have element(s) 22 and corresponding composite substrate 24 of a rectangular configuration of other overall geometrical shape.

Advantages to using the composite substrate 24 in the antenna can facilitate a high/acceptable gain UHF RFID antenna 10 with polarization diversity inside of an handheld computer 20 that also has other built in single/multiple communication technologies like WAN, WIFI, Bluetooth, GPS and other, for example. A further advantage is that by integrating the UHF RFID antenna 10 internally, the handheld's 20 dimensions (of the housing 100) and cost can be reduced while its ruggedness can be increased. Further, in being a directional antenna 10, the antenna 10 can operate along with/simultaneously the handheld's 20 other included communication technology without having adverse feedback problems between the antenna 10 and the other on-board communication technologies. For example, being able to work simultaneously with the WAN, WIFI and Bluetooth communication technologies, the antenna 10 incorporated into the handheld 20 can make the handheld applicable for real time inventory management.

Advantages to the antenna 10 design using the composite substrate 24 as discussed above can provide for advantages such as but nor limited to: reduced size of the overall dimensions of the antenna 10, as compared to other antennas, thereby providing the ability for the antenna 10 to be installed inside the handheld housing 100 (see FIGS. 4a,b) and not as an attachment to the handheld 20, which can increase the ruggedness of the handheld 20 and/or the internal antenna 10; address any undesirable decreases in gain due to reduction of the patch 22a width and length dimensions with a corresponding increase in thickness without an undesirable decrease in the overall dielectric constant of the composite substrate 24 by using separated dielectric layers 24a,b,c; circular polarization diversity; directionality; coexistence with other communication antennas 108 like WAN, WIFI, Bluetooth, GPS and other, inside of the same handheld 20; and simultaneous operability with other communication bands 108 like WAN, WIFI, Bluetooth, GPS and other. It is also recognized that the handheld 20 can be embodied as a generic mobile device such as a mobile communication device, the handheld as described, or a body-worn personal communication device.

The term “approximately,” as used herein, is synonymous with “about” and should generally be understood to refer to both numbers in a range of numerals. For example, “about 1 to 2” should be understood as “about 1 to about 2.” Moreover, all numerical ranges herein should be understood to specifically include each whole integer and each tenth of an integer within the range.

The foregoing discussion outlines features of several embodiments so that those of ordinary skill in the art may better understand the various aspects of the present disclosure describing the invention. Those of ordinary skill in the art should appreciate that they may readily use the present disclosure as a basis for designing or modifying other mechanical or electronic details for carrying out the same purposes and/or achieving the same advantages of the embodiments introduced herein. Those of ordinary skill in the art should also realize that such equivalent details do not depart from the spirit and scope of the present disclosure, and that they may make various changes, substitutions and alterations herein without departing from the spirit and scope of the present disclosure.

What is claimed is:

1. A microstrip antenna configured for at least one of transmission or reception of electromagnetic waves with respect to a surrounding environment, the antenna comprising:
an antenna element isolated from an electrical ground of the antenna and configured for operating as a radiating surface for the electromagnetic waves with respect to the surrounding environment;
a transmission line having a pair of electrical conductors such that a first conductor of the pair of electrical conductors is connected to the antenna element and a second conductor of the pair of electrical conductors is configured for coupling to the electrical ground, such that the transmission line is configured to conduct current flow for at least one of towards the antenna element for transmission of the electromagnetic waves from the antenna element or away from the antenna element as a result of reception of the electromagnetic waves by the antenna element; and
a composite substrate having a selected dielectric constant including a plurality of individual dielectric material layers in a stacked layer arrangement, such that the composite substrate is positioned between the antenna element and the electrical ground and the antenna element is attached to a first surface of the composite substrate.

2. The antenna of claim 1 further comprising each pair of the individual dielectric material layers being bonded to one another by a respective interposing bonding layer.

3. The antenna of claim 2, wherein the bonding layer is a doubled sided adhesive tape.

4. The antenna of claim 2, wherein the antenna element is a metallic patch selected from the group comprising: a two dimensional metallic sheet; and one or more metallic traces.

5. The antenna of claim 4, wherein the metallic sheet is a rectangular shape.

6. The antenna of claim 2 further comprising a grounding element attached to a second surface of the composite substrate, such that the first and second surfaces are in an opposed spatial relationship to one another.

7. The antenna of claim 6, wherein the second conductor of the pair of electrical conductors is connected to the grounding element and the grounding element is configured for coupling to the electrical ground.

8. The antenna of claim 6, wherein the ground element is a metallic sheet.

9. The antenna of claim 8, wherein the metallic sheet is in the shape of a rectangle.

10. The antenna of claim 9, wherein the electrical ground is provided by a handheld terminal and the current flow is provided by a power source of the handheld terminal for the transmission of the electromagnetic waves.

11. The antenna of claim 2 further comprising the antenna configured as circular polarization diversity.

12. The antenna of claim 11 further comprising a pair of orthogonal slots in the antenna element for facilitating tuning of a wavelength band of the antenna.

13. The antenna of claim 12, wherein the configuration of the pair of orthogonal slots provides for two different wavelength bands, such that the antenna is a dual band antenna.

14. The antenna of claim 11, wherein the effective dielectric constant of the composite substrate is greater than 9 and the thickness of the stacked layer arrangement is approximately ½ inch.

15. The antenna of claim 14, wherein the shape of the antenna is a rectangular shape and is configured for positioning as an internal antenna in a housing of a handheld device.

16. The antenna of claim 15, wherein a number of the plurality of individual dielectric material layers is 4.

17. An antenna apparatus comprising: an antenna element configured to be isolated from an electrical ground of the antenna; a transmission line having a pair of electrical conductors such that a first conductor of the pair of electrical conductors is connected to the antenna element and a second conductor of the pair of electrical conductors is configured for coupling to the electrical ground; and a composite substrate having a selected relative static permittivity including a plurality of individual relative static permittivity material layers in a stacked layer arrangement, such that the composite substrate is positioned between the antenna element and the electrical ground and the antenna element is attached to a first surface of the composite substrate.

18. The antenna apparatus of claim 17, wherein the antenna element is a configured as a radiating surface for electromagnetic waves in the UHF spectra.

19. A mobile computing device containing the antenna of claim 17 associated with a first transceiver, receiver or transmitter and containing or supporting at least one additional antenna connected to at least one additional transmitter, receiver or transceiver, such that the antenna and the additional antenna are configured for simultaneous operation.
